(19) United States
(12) Patent Application Publication
(10) Pub. No.: US 2015/0047721 A1
(43) Pub. Date: Feb. 19, 2015

(54) Uniform Gap Check Valve

(71) Applicant: Pulsafeeder, Inc., Rochester, NY (US)

(72) Inventor: John P. Hayles, Rochester, NY (US)

(21) Appl. No.: 14/462,221

(22) Filed: Aug. 18, 2014

Related U.S. Application Data
(60) Provisional application No. 61/866,754, filed on Aug. 16, 2013.

(51) Int. Cl. F16K 1/46; F16K 15/04

(52) U.S. Cl. CPC F16K 1/465; F16K 15/04
USPC 137/528

(57) ABSTRACT

A check valve for use in a fluid system such as, for example, a pump. The check valve includes a housing with an inlet, an outlet, and a fluidic chamber formed by an inner wall. The fluidic chamber includes an inlet orifice at a location where fluid flowing from the inlet enters the fluidic chamber. A check ball is disposed with the fluidic chamber of the housing. The check ball is movable between a “closed” position (wherein fluid is prevented from flowing from the outlet to the inlet) and an “open” position (wherein fluid is allowed to flow from the inlet to the outlet). When the check ball is in the open position, the fluid passage formed by the gap between the inner wall and the check ball, has a substantially uniform height.

### CROSS-REFERENCE TO RELATED APPLICATIONS

This application claims priority to U.S. Provisional Application No. 61/866,754, filed on Aug. 16, 2013, now pending, the disclosure of which is incorporated herein by reference in its entirety.

### FIELD OF THE DISCLOSURE

The present disclosure relates to check valves for use with pumps.

### BACKGROUND OF THE DISCLOSURE

Ball check valves are well-known in the art and are frequently used in fluid pumping applications. For example, check valves are frequently used with diaphragm pumps to move fluid through a system. Prior art check valves, such as the check valve shown in FIGS. 1A-2B, have been designed for manufacturability and are thought to be adequate in performance for typical applications.

### BRIEF SUMMARY OF THE DISCLOSURE

The present disclosure results from the discovery that prior art check valves are inefficient in performance due to non-uniformities of the fluidic chamber geometry. The present disclosure may be embodied as a check valve for use in a fluid system, the check valve comprising a housing having an inlet, an outlet, and a fluidic chamber formed by an inner wall. The fluidic chamber includes an inlet orifice at a location where fluid flowing from the inlet enters the fluidic chamber. The housing may further comprise a first member and a second member, each forming a portion of the fluidic chamber.

A check ball, which may be configured as a sphere, is disposed within the fluidic chamber of the housing. The check ball is movable within the fluidic chamber and, when in a “closed” position, the check ball is configured to cooperate with a valve seat of the fluidic chamber to prevent fluid from exiting the fluidic chamber by way of the inlet. In an “open” position, the check ball abuts a valve stop of the housing, the valve stop being configured to maintain the abutted check ball in a central location of the fluidic chamber. When the check ball is in the central location of the fluidic chamber, a fluid passage formed between the check ball and the inner wall of the housing is substantially uniform in height (where height is defined by the radial distance between the check ball and the inner wall of the housing).

### DESCRIPTION OF THE DRAWINGS

For a fuller understanding of the nature and objects of the disclosure, reference should be made to the following detailed description taken in conjunction with the accompanying drawings, in which:

FIG. 1A is a perspective, cross-section view of a prior art check valve;

FIG. 1B is the prior art check valve of FIG. 1A with shading to better show the components of the valve;

FIG. 2A is a cross-section of an elevational view of the prior art check valve of FIGS. 1A-1B;

FIG. 2B is the prior art check valve of FIG. 2A with shading to better show the components of the valve;

FIG. 3A is a perspective, cross-section view of a check valve according to an embodiment of the present disclosure;

FIG. 3B is the check valve of FIG. 3A with shading to better show the components of the valve;

FIG. 4A is a perspective, cross-section view of the check valve of FIGS. 3A-3B, wherein the check ball is not shown in cross-section;

FIG. 4B is the check valve of FIG. 4A with shading to better show the components of the valve;

FIG. 5A is a cross-section of an elevational view of the check valve of FIGS. 3A, 3B, 4A, and 4B; and

FIG. 5B is the check valve of FIG. 5A with shading to better show the components of the valve.

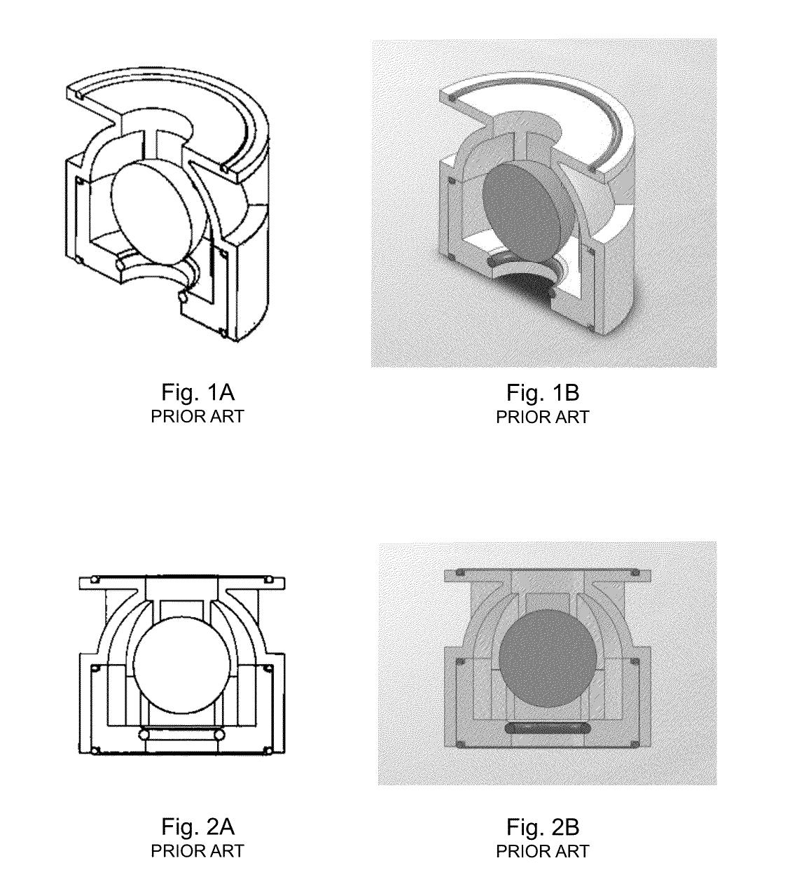

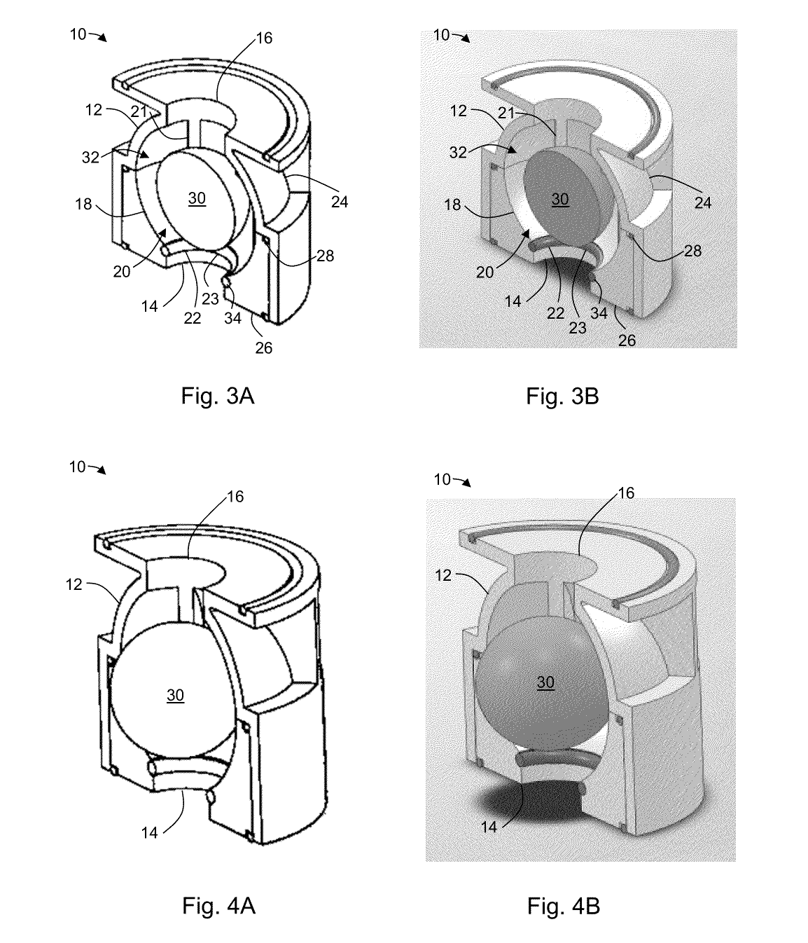

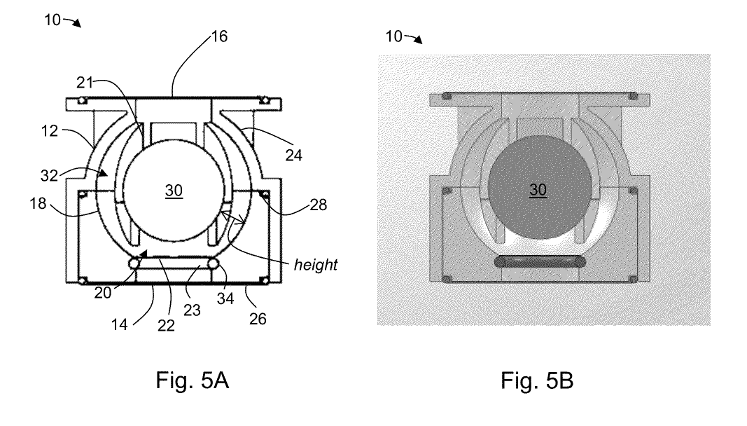

### DETAILED DESCRIPTION OF THE DISCLOSURE

The present disclosure may be embodied as a check valve 10 for use in a fluid system, such as, for example, a diaphragm pump. The check valve 10 includes a housing 12 with an inlet 14 and an outlet 16. The housing 12 has an inner wall 18 which forms a fluidic chamber 20. The fluidic chamber 20 is in fluid communication with the inlet 14 and the outlet 16 such that fluid may flow between the inlet 14 and the outlet 16 via the fluidic chamber 20. The fluidic chamber 20 includes an inlet orifice 22 at a location where fluid flowing from the inlet 14 enters the fluidic chamber 20.

A check ball 30 is disposed within the fluidic chamber 20 of the housing 12. The check ball 30 may be spherical in shape. The fluidic chamber 20 comprises a valve seat 23 at the inlet orifice 22 configured to cooperate with the check ball 30 to prevent fluid from exiting the fluidic chamber 20 by way of the inlet orifice 22. The valve seat 23 may further comprise a seat seal 34 configured to enhance the ability of the valve seat 23 and check ball 30 to prevent fluid flow. The seat seal 34 may be an o-ring. In other embodiments, the seat seal 34 is a knife-edge configuration or a conical configuration of the valve seat 23. Other valve seat 23 configurations are known and can be utilized. The housing 12 further comprises a valve stop 21.

The check ball 30 is movable within the fluidic chamber 20. The check ball 30 may be movable, for example, between a first position abutting the valve seat 23 at the inlet orifice 22 of the fluidic chamber 20, and a second position abutting the valve stop 21 of the housing 12. The check ball 30 may be moved by fluid flowing through the fluidic chamber 20 (i.e., caused by a difference in pressure at the inlet 14 and pressure at the outlet 16). For example, when fluid is caused to flow from the outlet 16 to the inlet 14, the fluid flow moves the check ball 30 to a position abutting the valve seat 23 (the “closed” position). Once the check ball 30 is in the closed position, no fluid can flow from the fluid chamber 20 to the inlet 14, and the check ball 30 is held in the closed position by the high pressure of fluid (high relative to a fluid pressure at the inlet 14).

When fluid is caused to flow from the inlet 14 to the outlet 16, the check ball 30 is moved by the fluid flow to a position abutting the valve stop 21 (the “open” position). When the check ball 30 is in the open position, a fluid passage 32 is formed in the space between the inner wall 18 of the housing and the check ball 30. The check valve 10 is advantageously configured such that the fluid passage 32 has a height (defined by the distance between the check ball 30 and the inner wall 18) that is substantially uniform around the check ball 30. In particular, the valve stop 21 is configured to position the check ball 30 in a central position of the fluidic chamber 20. The valve stop 21 may further comprise guiding ribs to efficiently guide the check ball 30 between the open position and the closed position. As such, the valve stop 21 may be configured as a three-point ball guide or a four point ball guide, or any other configuration capable of providing proper positioning of the check ball 30. Additionally, the fluidic chamber 20 has a geometry such that the fluid passage 32 is substantially uniform when the check ball 30 is in the central position. With a check ball 30 having a spherical shape, the fluidic chamber 20 has a corresponding spherical configuration (of course, the regions where fluid enters and exits the fluidic chamber 20 and the valve stop 21 are necessary disruptions to this spherical shape, and are not considered in the otherwise substantially uniform height of the fluid passage 32). In some embodiments, the central position of the check ball 30 in the fluidic chamber 30 may not be the geometric center of the fluidic chamber, such as, for example, where the check ball 30 and/or the fluidic chamber 20 are not spherical.

This uniform configuration provides notable improvements over prior art check valve configurations primarily in that turbulent flow and stagnant regions are greatly reduced or eliminated. The uniform gap additionally provides improved hydraulic accuracy and volumetric efficiency due to more precise and quick check ball 30 movement. The presently disclosed check valve 10 configuration is also better able to handle fluids containing solids than are conventional check valve designs because of the reduced or eliminated stagnant (low velocity) regions in which solids would otherwise accumulate and/or solidify causing valve movement or seating malfunctions.

Experimentation has shown the improved constant gap design to have lower pressure drop, which allows pumps using the check valve 10 to be used in more demanding low suction pressure available applications without causing cavitation in the process fluid. The gap (fluid passage 32) is constant but the velocity profile of a process fluid is variable. More particularly, the reduced area (cross-sectional area of the fluid passage 32) at the beginning of the check ball 30 movement cycle provides quick response to lift the ball 30 off the seat 23. The velocity of the fluid around the check ball 30 is the lowest when the ball 30 reaches its upper stop 21 position due to the largest area existing at that location.

The housing 12 may comprise a first member 24, making up a first portion of the inner wall 18, and a second member 26, making up a second portion of the inner wall 18. A housing seal 28, such as, for example, an o-ring, may be disposed between the first member 24 and the second member 26. Such a two piece housing 12 design may be utilized to produce a fluidic chamber 20 having the required configuration. For example, production of a spherical fluid chamber 20 may otherwise be difficult using high-volume manufacturing techniques. In other embodiments, housings 12 may comprise additional numbers of constituent members.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A check valve for use in a fluid system, comprising:
a housing having an inner wall forming a fluidic chamber, an inlet in fluid communication with the fluidic chamber, an outlet in fluid communication with the fluidic chamber, and at least one valve stop, wherein the fluidic chamber comprises a valve seat at an inlet orifice;
a check ball enclosed within the fluidic chamber of the housing; and
wherein fluid flow from the inlet, through the fluidic chamber, and to the outlet causes the check ball to abut the at least one valve stop thereby forming a fluid passage between the inner wall and the check ball, and wherein the height of the fluid passage is substantially uniform, and wherein the check valve abuts the valve seat to prevent fluid flow from the outlet to the inlet.

2. The check valve of claim 1, wherein the check ball is a sphere.

3. The check valve of claim 1, wherein the housing further comprises a first member making up a first portion of the fluidic chamber and a second member making up a second portion of the fluidic chamber.

4. The check valve of claim 3, wherein the housing further comprises a housing seal at an interface of the first member and the second member.

5. The check valve of claim 1, wherein the valve seat comprises a seat seal.
